(19) United States
(12) Patent Application Publication
(10) Pub. No.: US 2014/0164058 A1
(43) Pub. Date: Jun. 12, 2014

(54) SYSTEM AND METHOD FOR PROVIDING A MULTILATERAL TRANSACTION DATA MART

(71) Applicant: Capital One Financial Corporation, McLean, VA (US)

(72) Inventors: Luke A. HAMMOCK, Washington, DC (US); Janusz Michael NICZYPORUK, Vienna, VA (US)

(73) Assignee: Capital One Financial Corporation, McLean, VA (US)

(21) Appl. No.: 14/100,406

(22) Filed: Dec. 9, 2013

Related U.S. Application Data
(60) Provisional application No. 61/735,163, filed on Dec. 10, 2012.

(51) Int. Cl. G06Q 30/02

(52) U.S. Cl. CPC G06Q 30/0201
USPC 705/7.29

(57) ABSTRACT

Systems and methods include multilateral transaction data mart, including one or more institutions, a central party, and a centralized database. Additionally, example embodiments may receive information from a one or more institutions, store the information in a centralized database, and provide information to one or more institutions upon request. Further, a system and method in accordance with example embodiments may include sending information to a centralized database, sending a request to the centralized database for information regarding one or more users, and receiving information regarding one or more users.

### PRIORITY

This application claims the benefit of priority to U.S. Provisional Application No. 61/735,163, filed Dec. 10, 2012, the contents of which is incorporated herein in its entirety.

### FIELD OF THE DISCLOSURE

The present disclosure relates to systems and methods for a transactional data mart and, more particularly, for providing and managing a multilateral transactional data mart.

### BACKGROUND

Consumers frequently utilize a variety of payment cards, accounts, and methods. For example, consumers may use a credit card, a debit card, a prepaid card, a demand deposit account (DDA), a gift card, a loyalty card, an e-commerce payment method that is linked to a payment account, such as PayPal, or the like when making payments. Often these various payment cards, accounts, and methods are associated with different entities or providers, thereby depriving a single entity of “full wallet” coverage of and/or visibility into customer activities.

From the consumer perspective, the lack of a single entity having this visibility into a customer's activities may prevent the consumer from realizing the available benefits when a more comprehensive view of the consumer's payment activities is known.

These and other drawbacks exist

### SUMMARY

In one example embodiment, the present disclosure is directed to a system that includes a communication module to facilitate communication with one or more institutions, a centralized database that stores user information associated with a unique identifier, one or more processors associated with the centralized database to receive transaction information and customer information from the one or more institutions and store said information in the centralized database, and a request handler to receive requests for information one of the one or more institutions, determine whether the request complies with one or more usage limitations associated with the one of the one or more institutions, and provide the information to the one of the one or more institutions.

In some aspects, the system may further include one or more processors associated with the centralized database to monitor transaction information to determine whether provided information has been utilized by a user of the one of the one or more institutions.

In an example embodiment, the present disclosure is directed to a method that includes facilitating communication with one or more institutions via a network, establishing a centralized database that stores user information associated with a unique identifier, receiving transaction information and customer information at the centralized from the one or more institutions via the network, storing said information in the centralized database, receiving requests for information one of the one or more institutions via the network, determining whether the request complies with one or more usage limitations associated with the one of the one or more institutions, and providing the information to the one of the one or more institutions via the network.

In some aspects, the method may further include monitoring transaction information, and determining whether provided information has been utilized by a user of the one of the one or more institutions.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 is a block diagram illustrating an example system implementing a multilateral transaction data mart according to an embodiment of the disclosure;

FIG. 2 is a block diagram illustrating an example data storage scheme according to an embodiment of the disclosure;

FIG. is a block diagram illustrating an example data storage scheme according to an embodiment of the disclosure;

FIG. 4 is a flowchart illustrating an example method utilizing a multilateral transaction data mart according to an embodiment of the disclosure; and

FIG. 5 is a flowchart illustrating an example method utilizing a multilateral transaction data mart according to an embodiment of the disclosure.

### DETAILED DESCRIPTION OF THE EMBODIMENTS

The following description is intended to convey a thorough understanding of the embodiments described by providing a number of specific embodiments and details involving a multilateral transaction data mart. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

Embodiments of the present teachings generally relate to systems, methods, and devices for capturing information, collecting and organizing the captured information, providing all or a subset of the information to one or more entities, and using the provided information in connection with one or more customers. More particularly, the disclosed embodiments relate to systems, methods, and devices for providing a multilateral transaction data mart that allows customers to utilize multiple payment cards or methods, while still permitting one or more single entities “full wallet” coverage of and/or visibility into customer activities and thereby harnessing the predictive power of purchase data. The disclosed embodiments can be used, for example, in connection with systems or applications having processes that pool customer data into a central repository to allow each contributing entity to optimize targeting and distribution of advertisements and/or offers to its customers.

In an example embodiment, a multilateral transaction data mart provides full-wallet visibility to all eligible institutions, improving their targeting abilities and increasing the credibility of the banks as providers or advertising and/or offers. Consenting institutions may send a list of participating users (e.g., customers) to a central party. The central party may be a third-party vendor that, in some embodiments, may be anonymous. The central party may analyze the list using one or more computer processors. The list may be analyzed to determine unique users and identify customer overlap between and among institutions.

Reference will now be made in detail to examples of embodiments of the present teachings, which are illustrated in the accompanying drawings. Where possible the same reference numbers will be used throughout the drawings to refer to the same or like parts. While several example embodiments and features are described herein, modifications, adaptations and other implementations are possible, without departing from the spirit and scope of the disclosure. For example, substitutions, additions or modifications may be made to the components illustrated in the drawings, and the example methods described herein may be modified by substituting, reordering or adding steps to the disclosed methods. Accordingly, the following detailed description does not limit the disclosure.

As used herein, a financial institution and system supporting a financial institution are used as examples for the disclosure. The disclosure is not intended to be limited to financial institutions only. For example, the systems and methods may function with any business, individual, and/or any entity that may provide a payment account or allows you to service a payment account including credit cards, debit cards, prepaid cards, stored value accounts, gift cards, and accounts that have underlying links to any of the aforementioned accounts.

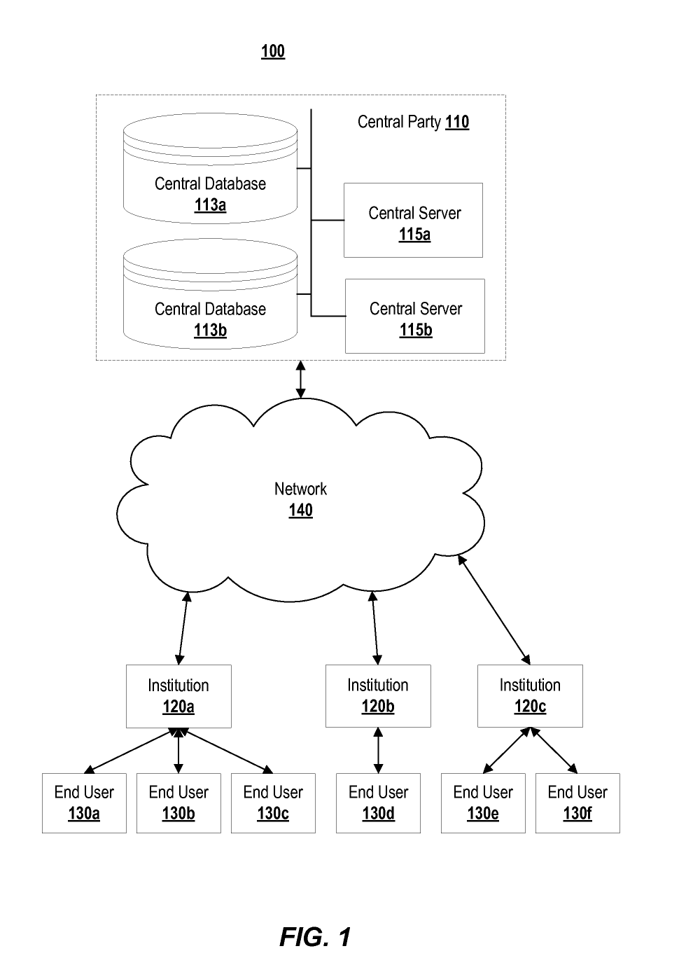

FIG. 1 is a block diagram of an example multilateral transaction data mart system 100 arranged to capture information, collect and organize the captured information, provide all or a subset of the information to one or more entities, and utilize the provided information in connection with one or more users, consistent with certain disclosed embodiments. It should be readily apparent to one of ordinary skill in the art that the example computing system depicted in FIG. 1 represents a generalized schematic illustration and that other components/devices can be added, removed, or modified. As shown in FIG. 1, system 100 can include central party 110, one or more institutions 120 (e.g., institution 120a, institution 120b, and institution 120c), one or more end users 130 (e.g., end user 130a, end user 130b, end user 130c, end user 130d, end user 130e, and end user 130f), and network 140.

Central party 110 may include one or more central databases 113 (e.g., central database 113a, central database 113b, etc.) and one or more central servers 115 (e.g., central server 115a, central server 115b, etc.). Central party 110 may manage one or more central databases 113 via one or more central servers 115. For example, central party 110 may generate a unique identifier (“ID”), associate the unique ID to an end user 130, and store the unique ID and its association with the end user 130 in central databases 113. The unique IDs may allow end users 130 to be consistently identified across institutions 120. Additionally, the ID may be used to shield the identity of the user and/or protect the user's personally-identifiable information. That is, the information stored in the centralized database may be anonymized by removal of personally-identifiable information from central database 113, and the unique ID may be used instead to allow central party 110 and institutions 120 to exchange information without exposing personally-identifiable information.

Central databases 113 may collect, store, manage, and otherwise deal with information pertaining to a plurality of end users 130. Central databases 113 may receive the collected and stored information from the one or more institutions 120 via central servers 115. In some embodiments, central databases 113 may collect the information received from a number of institutions and may use one or more central servers 115 to create a “pool” of information. Central party 110 may implement one or more rules to restrict access to central databases 113. As one example, central party 110 may impose one or more rules that limit or restrict data from being provided by one or more pre-determined institutions 120 to central party 110 for analysis and storage in central databases 113. As another example, central party 110 may impose one or more rules that limit or restrict access of one or more pre-determined institutions 120 to data stored in central databases 113, analyzed by central servers 115, and/or provided by central party 110. Pre-determined institutions 120 may include, for example, one or more of those institutions 120 that pay a usage or support fee, provide reciprocal access to data, or otherwise meet requirements defined by central party 110.

By way of example and not by limitation, central party 110 may assign usage limitations to one or more pre-determined institutions 120, and the limitations may impose restrictions on the use of data stored in central databases 113, analyzed by central servers 115, and/or provided by central party 110 by one or more pre-determined institutions 120. Usage limitations may include, for example, allowing institutions 120 access to a proportion of customers in accordance with the size of the institution (e.g., a bank that contributes data corresponding to 1 million unique users would have access to 1/10^{th} of the customers as that of a bank that contributes data corresponding to 10 million users), allowing institutions 120 access to a proportion of end user 130 data in accordance with the amount of information contributed by that institutions 120, or any other possible means of limitation, forbidding use of data stored in central databases 113 for new customer acquisition, restricting access to central databases 113 to only those IDs previously provided by an institution 120, etc. The restrictions and limitations on access to data stored in central databases 113, analyzed by central servers 115, and/or provided by central party 110 may be established by central party 110 and enforced through one or more applications executing on central servers 115.

As disclosed herein, a central server 115 may be computer hardware and/or software that makes available a service that, for example, can be accessed by one or more clients. For example, a central server 115 may be a computer system used to provide one or more network services to one or more clients. As such, a central server 115 may run one or multiple servers to provide services over network employing some communications protocol to its clients. Central server 115 also may provide enable a data storage, manipulation, presentation, communication or other shared functions provided by the server and consumed by clients. In the example embodiments disclosed herein, the central servers 115 may make the following services accessible by one or more clients: data transmission and storage and other services related to providing a multilateral transaction data mart.

In various example embodiments, central server 115 may employ a service-oriented architecture. In so doing, central server 115 may make available one or more of the above-mentioned services or other services or units of functionality. Each service or unit of functionality may implement one action, for example, such as data communication, data storage, responding to data requests, and the like. Within central server 115, services may use defined protocols that describe how services pass and parse messages using description metadata. Also, services can be combined by other software applications within central server 115 to provide the complete functionality of software application, such as for example, a multilateral transaction data mart.

Although only one central party 110 is depicted in FIG. 1, more than one central party 110 may perform the methods disclosed herein. The one or more central parties 110 may operate independently. The one or more central parties 110 also may operate together, whether that be cooperatively and/or supportively. Thus, when there is more than one central party 110, the data maintained by each central party 110 may be the same, either in whole or in part, or it may be different. As one example, multiple central parties 110 may contain consumer information related to the same end user 130, but may retain different transactional information related to that same end user 130 that may be, for example, supplied by different institutions 120. It is understood that central party 110 may be one or more institutions 120, may be associated with one or more institutions 120, or may be a third-party unrelated to institutions 120.

Central party 110 may implement security protocols and safeguards to protect user information. For example, the central party may implement encryption, authentication, firewalls, or any other security protocol.

System 110 may include one or more institutions 120. The one or more institutions 120 may be any type of financial institution including, by way of example and not limitations, depository institutions (e.g., banks, credit unions, building societies, trust companies, mortgage loan companies, pre-paid gift cards or credit cards, etc.), contractual institutions (e.g., insurance companies, pension funds, mutual funds, etc.), investment institutions (e.g., investment banks, underwriters, brokerage funds, etc.), and other non-bank financial institutions (e.g., pawn shops or brokers, cashier's check issuers, insurance firms, check-cashing locations, payday lending, currency exchanges, microloan organizations, crowd-funding organizations, third-party payment processors, etc.).

In various embodiments, one or more institutions 120 may be any type of institution that collects and/or processes transaction data related to its end users. For example, institutions 120 may relate to social media services, email services, mobile services, and any other types of institutions that may have end users that are associated with multiple like institutions. For example, where institutions relate to social media services, institutions such as Facebook, Twitter, LinkedIn, Instagram, and the like, may have users with accounts at each respective social media entity and may maintain transaction data about the user on each respective social media site.

In one example embodiment, institutions 130 may perform financial transactions (e.g., process transactions by a third-party payment processor, etc.) or enable the performance of financial transactions (e.g., issue cards or other financial accounts) on behalf of one or more end users 130. Using the example of issuing cards or financial accounts, institutions 130 may receive or gather information about each of end user 130. The information may include personally-identifiable information, such as, for example, name, address, phone number, email address, social security number, income, employer, credit history, gender, demographic data, etc. The information may also include transaction information, such as, for example, dates and/or times of purchases, identity of merchant from whom purchases are made, location of the purchase (physical or digital location), listing and/or descriptions of the products purchased, quantities purchased, the amount of taxes paid for the purchase, the amount of discount redeemed during the purchase, the shipping address and/or billing address associated with the purchase (if applicable), the name of the purchaser, the currency used, the shopping ‘lane’ and/or ‘terminal’ used to make the purchase, etc.

Institutions 130 may transmit the collected information to one or more central parties, such as central party 110. The information sent may include customer and/or transaction information, and may be sent at one or more predetermined intervals. The predetermined intervals may be hourly, daily, weekly, monthly, quarterly, yearly, or any other possible interval. In embodiments, institutions 130 may transmit the collected information to central party 110 using a unique ID, thereby eliminating the use of personally-identifiable information. In certain embodiments, an institution 120 may send customer information having personally-identifiable information for an end user 130 to central party 110, whereupon central party 110 will send to the institution 120 a unique ID corresponding to the end user 130. After receiving the unique ID and associating the unique ID with the end user 130, institution 120 may thereafter transmit information related to the end user 130 to central party 110 using the unique ID to identify the end user 130 with whom the transmitted information is to be associated.

End users 130 may be customers of institutions 120. That is, end users 130 may use financial services and/or other services provided by one or more institutions 120, such as those discussed above. As shown in FIG. 1, one or more end users 130 may be associated with a single institution 120. Although not illustrated, a single end user 130 may be associated with more than one institution 120. An end user 130 may be an individual entity or combination of entities, such as, by way of example and not limitation, persons, non-profit organization, corporations or businesses, governmental or educational institutions, etc.

Network 140 may enable communication between a centralized database 113, one or more institutions 120, and a central party 110. For example, Network 140 may be one or more of a wireless network, a wired network or any combination of wireless network and wired network. For example, network 140 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal.

In addition, network 140 may include, without limitation, telephone lines, fiber optics, IEEE Ethernet 902.3, a wide area network (“WAN”), a local area network (“LAN”), or a global network such as the Internet. Also network 140 may support an Internet network, a wireless communication network, a cellular network, or the like, or any combination thereof. Network 140 may further include one network, or any number of the example types of networks mentioned above, operating as a stand-alone network or in cooperation with each other. Network 140 may utilize one or more protocols of one or more network elements to which they are communicatively coupled. Network 140 may translate to or from other protocols to one or more protocols of network devices. Although network 140 is depicted as a single network, it should be appreciated that according to one or more embodiments, network 140 may comprise a plurality of interconnected networks, such as, for example, the Internet, a service provider's network, a cable television network, corporate networks, and home networks.

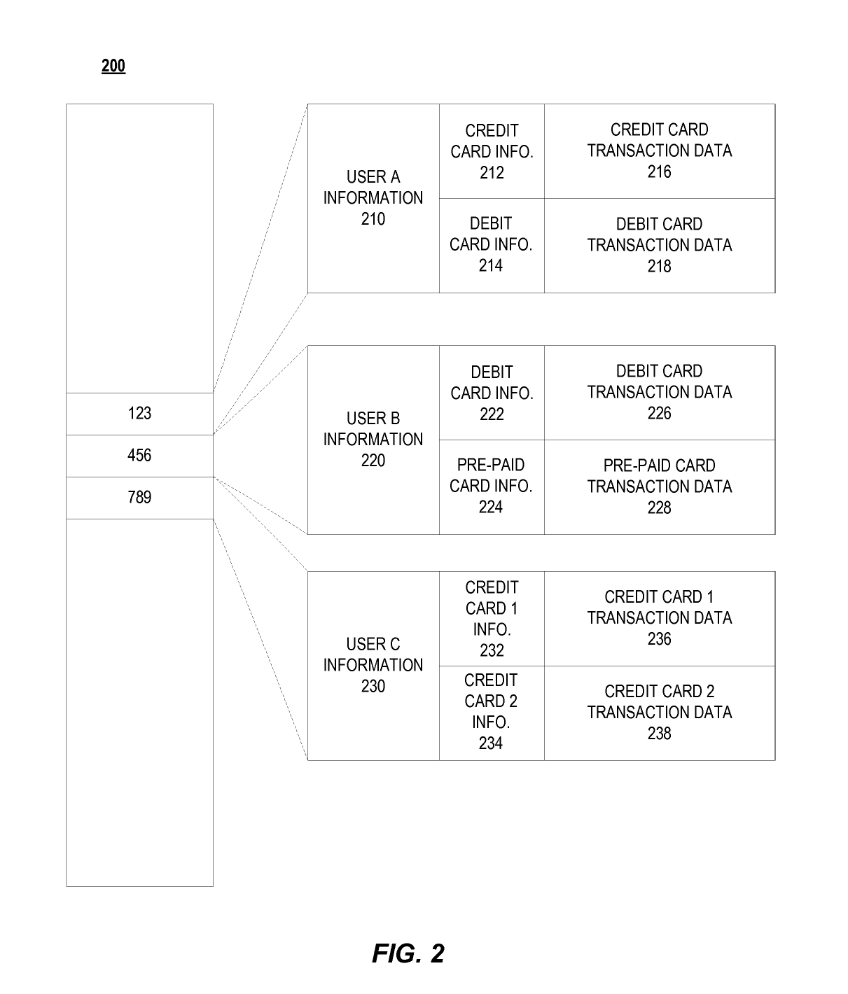

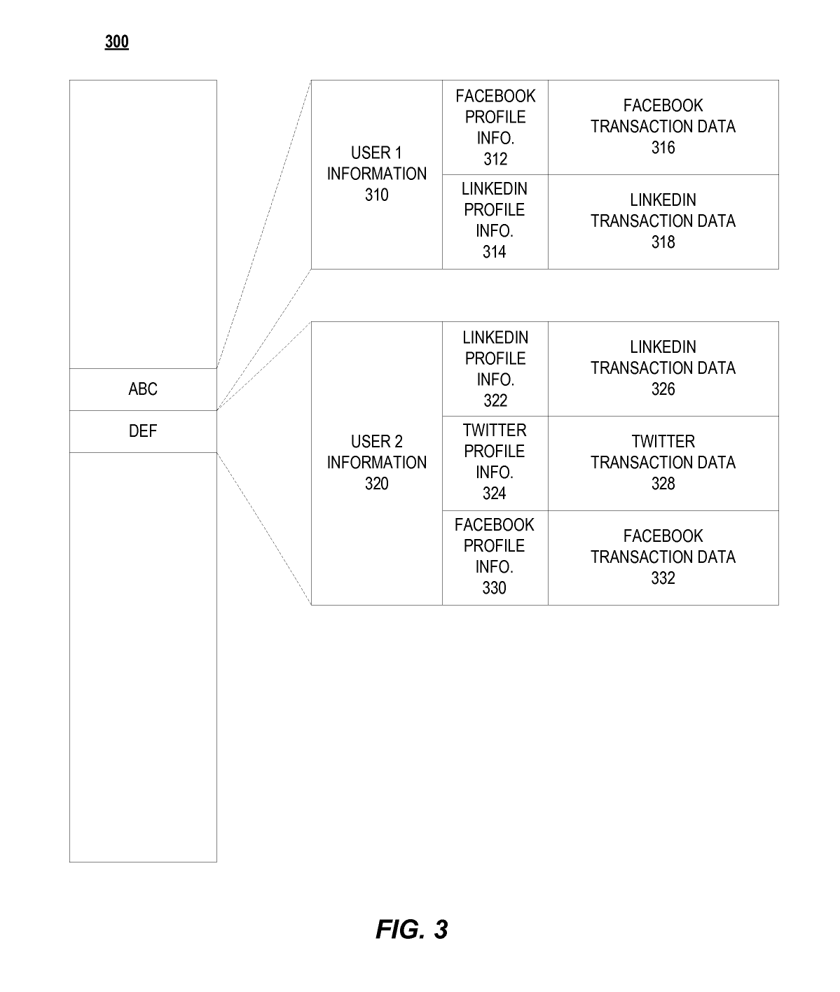

FIG. 2 illustrates an example data storage scheme 200 according to an embodiment of the disclosure. Data storage scheme 200 may be implemented in, for example a database associated with a central party. The database may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

As illustrated in FIG. 2, data storage scheme 200 may include a plurality of entries 123, 456, and 789. Each of the plurality of entries may, for example, relate to a unique ID established by a central party. And each unique ID may relate to information about a particular user. For example, as shown in FIG. 2, entry 123 may relate to unique ID 123, which is associated with user A information. Entry 456 may relate to unique ID 456, which is associated with user B information. Entry 789 may relate to unique ID 789, which is associated with user C information. Each entry may “pool” the transaction data associated with a particular user from various institutions as shown in FIG. 2. For example, entry 123 may include user A information 210. User A information 210 may include information about user A including, without limitation, name, address, phone number, email address, date of birth, social security number, income, employer, credit history, gender, demographic data, etc. User A information 210 may be associated with user A credit card information 212 and user A debit card information 214. User A credit card information 212 may include a credit card number, expiration date, billing information, information about the issuing institution, and other like information associated with a credit card account. User A debit card information 214 may include a debit card number, expiration date, billing information, information about the issuing institution, and other like information associated with a credit card account.

User A credit card information 214 be associated with user A credit card transaction data 216 and user A debit card information 216 may be associated with user A debit card transaction data 218. User A credit card transaction data 216 may include information about the transactions associated with a user A credit card. For example, credit card transaction data 216 may include information about each purchase made by user A with the credit card including, the purchase amount, merchant, time/date of purchase, location of the merchant (e.g., geo-coded information about the merchant), the type of merchant, a category of the purchase (e.g., restaurant, travel, utility, etc.) and the like. User A debit transaction data 218 may include information about each purchase made by user A with the debit card including, the purchase amount, merchant, time/date of purchase, location of the merchant (e.g., geo-coded information about the merchant), the type of merchant, a category of the purchase (e.g., restaurant, travel, utility, etc.) and the like.

In various embodiments, user A credit card information 212 may be associated with a first institution while user B debit card information may be associated with a second institution. Enabling a central party, for example, to “pool” user A's credit card transaction data from a first financial institution with user A's debit card transaction data from a second financial institution allows the first and second financial institutions to have “full wallet” information about user A. First and second financial institutions therefore may be able to better target user A with advertisements.

As shown in FIG. 2, entry 456 may be associated with user B information 220. User B information 220 may be associated with user B debit card information 222, which may be similar to debit card information 214. User B information 220 also may be associated with pre-paid card information 224, which may include a card number, billing information, information about the issuing institution, and other like information associated with a pre-paid card account. User B debit card information may be associated with debit card transaction data 226, which may be similar to debit card transaction card data 218. User B pre-paid card information 224 may be associated with pre-paid card transaction data 228, which may include information about each purchase made by user B with the pre-paid card including, the purchase amount, merchant, time/date of purchase, location of the merchant (e.g., geo-coded information about the merchant), the type of merchant, a category of the purchase (e.g., restaurant, travel, utility, etc.) and the like.

Also as shown in FIG. 2, entry 789 may be associated with user C information 230. User C information 230 may be associated with user C credit card information 232 and user C credit card information 234, both of which may be similar to credit card information 212. In various embodiments, user C credit card information 232 may be associated with a first financial institution and user C credit card information 234 may be associated with a second financial institution. Credit card 1 transaction data 236 and credit card 2 transaction data 238 may be similar to credit card transaction data 216.

FIG. 3 illustrates an example data storage scheme 300 according to an embodiment of the disclosure. Data storage scheme 300 may be implemented in, for example a database associated with a central party. The database may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

As illustrated in FIG. 3, data storage scheme 300 may include a plurality of entries ABC and DEF. Each of the plurality of entries may, for example, relate to a unique ID established by a central party. And each unique ID may relate to information about a particular user. For example, as shown in FIG. 3, entry ABC may relate to unique ID ABC, which is associated with user A information. Entry DEF may relate to unique ID DEF, which is associated with user B information.

Each entry in FIG. 3 may “pool” the transaction data associated with a particular user from various institutions as shown in FIG. 3. In the example illustrated in FIG. 3, the institutions relate to social media services and the transaction data may therefore relate to social media transaction data for respective social media users across various social media platforms. For example, entry ABC may include user 1 information 310. User 1 information 310 may include information about user A including, without limitation, name, address, phone number, email address, date of birth, social security number, income, employer, credit history, gender, demographic data, etc. User 1 information 310 may be associated with user 1 Facebook profile information 312 and user 1 LinkedIn profile information 314. User 1 Facebook profile information 312 may include a login, password, information about the Facebook user 1, information to digital images related to user 1, information about the Facebook friends of user 1, information about the groups Facebook user 1 joined, information about the things Facebook user 1 likes, and/or any other Facebook profile information. User 1 LinkedIn profile information 314 may include a login, password, information about the LinkedIn user 1, including employment history, education, and other experiences, information to digital images related to user 1, information about the LinkedIn connections of user 1, information about the groups LinkedIn user 1 has joined, information about the companies or other entities LinkedIn user 1 is following and/or any other LinkedIn profile information.

User 1 Facebook profile information 312 be associated with user 1 Facebook transaction data 316 and user 1 LinkedIn profile information 314 may be associated with user 1 LinkedIn transaction data 318. User 1 Facebook transaction data 316 may include information about the transactions associated with a user 1 Facebook profile. For example, Facebook transaction data 316 may include information relating status updates made by user 1 using the Facebook profile including, the words in a status update, photos, likes, links friends added, groups joined click through data and the like. User 1 LinkedIn transaction data 318 may include information about the transactions associated with a user 1 Linked profile. For example, LinkedIn transaction data 318 may include information relating status updates made by user 1 using the LinkedIn profile including, the words in a status update, photos, likes, links, connections made, groups joined, companies being followed, click through data and the like.

Entry DEF may related to user 2 information which may be similar to user 1 information as described above. As illustrated in FIG. 3, LinkedIn profile information 322 may be similar to LinkedIn profile information 314 and LinkedIn transaction data 326 may be similar to LinkedIn transaction data 318. Similarly, Facebook profile information 330 may be similar to Facebook profile information 312 and Facebook transaction data 332 may be similar to Facebook transaction data 316.

User 2 information also may include Twitter profile information 324. User 2 Twitter profile information 324 may include a login, password, information about the Twitter user 2, information to digital images related to user 2, information about the Twitter followers of user 2, information about the Twitter users user 2 is following, and/or any other Twitter profile information. User 2 Twitter profile information 324 be associated with user 2 Twitter transaction data 328. User 2 Twitter transaction data 328 may include information about the transactions associated with a user 2 Twitter account. For example, Twitter transaction data 328 may include information relating tweets made by user 2 using the Twitter account, including, the tweets, retweets, replies, hash tags used, photos tweeted, click through data and the like.

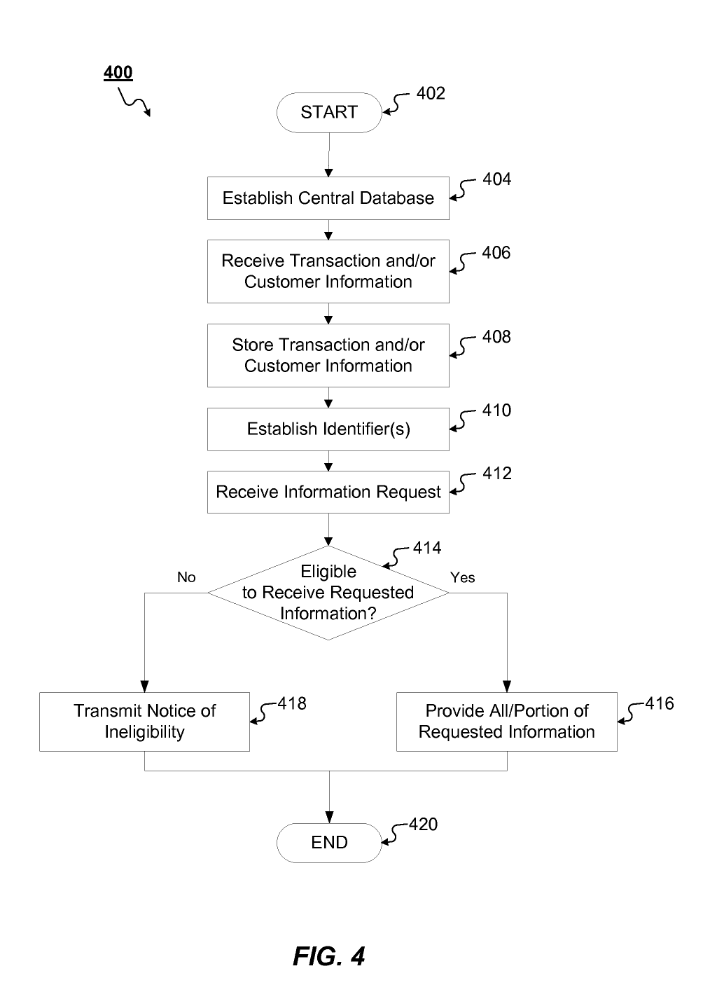

FIG. 4 provides an example method 400 for utilizing a multilateral transaction data mart. At block 402, the method may start. At block 404, a centralized database may be established, for example, by a central party. The centralized database may be capable of containing multiple portions of data pertaining to a customer and/or a transaction. The centralized database also may be capable of storing any other information relevant to the system or method. For example, the centralized database may store information in a manner similar to as described in FIGS. 2 and 3.

At block 406, a party may receive transaction and/or customer information. The information received may include, but is not limited to, name, address, social security number, income information, transaction information, demographic information, or any other information relevant to the system or method. In various embodiments, the received information may originate from, for example, each consenting or participating party. As described above, transaction information may include information about the transactions associated with the respective users. Where, for example, the transactions are purchase transactions, the transaction may include transaction data similar to as described above with respect to FIG. 2. Where, for example, the transactions are social media transactions, the transaction may include transaction data similar to as described above with respect to FIG. 3. At block 408, the party may store the transaction and/or customer information in the centralized database.

At block 410, an identifier (or “ID”) may be established for the customer and/or transaction information. To establish an identifier, the central party may, for example, analyze a list of customer and/or transaction data received to determine overlap of information/customers between institutions. For example, the central party may analyze the customer and/or transaction data received to determine that a credit card user at one institution is the same user as debit card user at another institution. In this example, the central party may use customer information such as the user name and/or social security number to determine that the users are the same. In the example where the institutions are social media entities, the central party also may use user login and password and/or other customer information, for example, to determine that one user is the same user at multiple institutions. Upon finding an identifiable portion of information or a customer, an identifier may be assigned to that information or customer. The ID may allow users to be consistently identified across institutions, and may be an identifier unique to a customer, institution, database, or any other possible identification scheme. For example, as shown in FIG. 2, the user who has a credit card at a first institution and a debit card at a second institution may be identified as user A, or unique ID 123. Similarly, the user that has a Facebook profile “John Doe”, a LinkedIn profile “John Doe”, and a Twitter handle @johndoe may be identified as user 2, or unique ID DEF.

At block 412, the party may receive an information request from an institution. An information request may include, but is not limited to, an identifier and a request to retrieve information linked to that identifier. For example, the identifier may uniquely identify a customer who has a relationship with one or more financial institutions, and the request may designate the requested information as information about one or more transactions made by a customer.

At block 414, the party may determine what information, if any, the institution is entitled to receive. For example, the party may analyze the applicability of one or more usage limitations to determine whether the institution is entitled to the requested information. A usage limitation may include, for example, allowing an institution access to a proportion of customers in accordance with the size of the institution (e.g., a bank that has 1 MM customers would be able to distribute ads to 1/10^{th} of the customers as a bank with 10 MM customers), allowing an institution access to a proportion of customers in accordance with the amount of information contributed by that institution, or any other possible means of limitation. The centralized database may optionally place additional or alternate restrictions on the flow of data. For example, an institution may be unable to utilize the centralized database for new customer acquisition. Also, the centralized database may optionally restrict the use of the database to only IDs previously provided by the institution. Also, the centralized database may otherwise restrict the use of information in the database. The party will determine what information the institution is entitled to receive based on these or other criteria. At block 416, the party may provide the information to the institution. For example, the information provided by the party may include the information may include a customer's name, address, social security number, income information, transaction information, demographic information, or any other information relevant to the system or method. If a party is not eligible, a notice of ineligibility may be transmitted to that party in block 418. At block 420, the method may end.

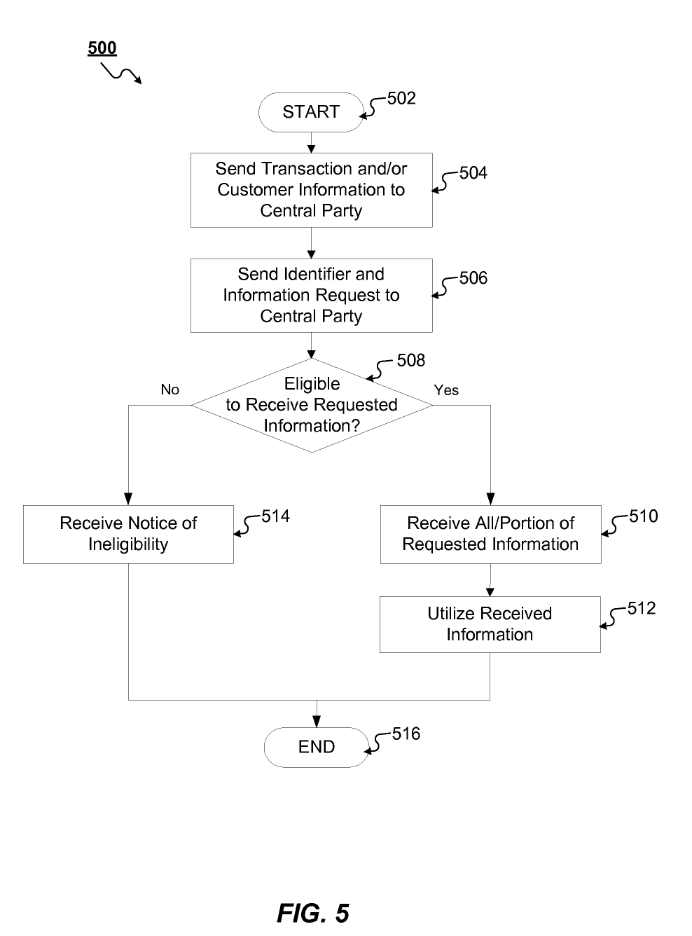

FIG. 5 provides an example method 500 for utilizing a multilateral transaction data mart. At block 502, the method may start. At block 504, an institution may send information regarding a customer, account, and/or transaction to a central party. For example, the information may include, but is not limited to, name, address, social security number, income information, transaction information, demographic information, or any other information relevant to the system or method.

At block 506, the institution may send an identifier with an information request to the central party. The identifier may include, but is not limited to, an ID code allowing a customer to be consistently identified across institutions, and may be an identifier unique to a customer, institution, database, and/or any other possible identification scheme. The information request may include, but is not limited to, a request for information pertaining to a customer and/or a transaction. For example, a financial institution may request information pertaining to a customer's transactions and/or purchases.

At blocks 508-510, the institution may receive information from the centralized database related to the request if it is determined that the institution is eligible to receive the requested information or a portion thereof. For example, the information received may include a customer's name, address, social security number, income information, transaction information, demographic information, or any other information relevant to the system or method. At block 512, the institution may utilize the information received from the central party. For example, the institution may utilize the information to provide an advertisement, offer, coupon, or other message. Also, the institution may utilize the information to perform data analysis and monitor the advertisement or offer to determine whether the offer or advertisement or offer was utilized. In various embodiments, the institution may coordinate and communicate with a central party if a central party is monitoring the transaction data to determine whether an offer or advertisement has been utilized. If a party is not eligible, a notice of ineligibility may be transmitted to that party in block 514. At block 516, the method may end.

In an example embodiment, an institution may determine that it wants to target a customer for an advertisement, offer, coupon, or other message. An advertisement may comprise any communication to a customer and/or personalization of customer experience that is intended to: provide discounts, promote product features, alter customer buying behavior, request feedback on products, solicit referral activity, signing up customers for loyalty programs, create consumer awareness of a product, or any other communication and/or personalization of customer experience. An advertisement may be, for example, and these messages may be displayed in any number of media and/or channels: bank statement, website, mobile device, affiliate/partner website, ATM screen, radio station, television advertisement, or any other form. To target a customer, an institution may determine that customer's ID. The institution may optionally contact the centralized database with a request that may include the customer's ID. The centralized database may respond, optionally in real-time, with a set of information to enable targeting of the advertisement, offer, coupon, or other message. The information may include, for example, a list of transactions, a metric, a score, customer category information, or any other information regarding a customer. For example, the information may be tailored, customized, and/or refined based upon previously pooled or consolidated information.

In an example embodiment, upon receiving the information from the centralized database, an institution may utilize the information to deliver the advertisement, offer, coupon, or other message to the customer. The institution may customize the advertisement, offer, coupon, or other message according to the information. For example, and not by way of limitation, the institution may select, customize, or alter an advertisement, offer, coupon, or other message for relevance based on historical purchase patterns, or segmentation of existing repeat customers, or integrate the information with additional forms of data for greater granularity (e.g., geolocation, social graph).

The advertisement, offer, coupon, or other message according to the information may be actionable by a customer. For example, an institution may send a user a discount offer on a given product and/or from a given retailer. The user may then redeem the offer for the product and/or at the retailer. Additionally, the system and process may function in multiple directions. For example, if an institution sends a message to the customer (e.g., “You've spent $2100 on your Gold and Platinum credit cards in the past 4 weeks” or “You've spent $500 on clothing in the past 2 months”) a customer may respond to the institution (e.g., “at what merchants have I spent the most money”). In an example embodiment, the message may be routed through the central database for appropriate attribution (e.g., the central database would want to keep accurate information about which customers respond, how they respond, and the types of messages that get them to respond). Also, the system may completely or partially anonymize some or all customer information (e.g., institutions may only know that they are messaging unique ID #529 but not the actual customer information for said ID), the system may optionally prevent inappropriate matching the Unique ID to specific customer (e.g., the institution sends a message to Unique ID #821 and they get a response from John Doe—it now knows ID 821=John Doe).

The institution may deliver the advertisement, offer, coupon, or other message to the customer and provide notification to the centralized database that the advertisement, offer, coupon, or other message has been delivered. The institution may optionally report the details of the offer to the centralized database. The centralized database may monitor incoming information from some or all institutions for a customer action related to the advertisement, offer, coupon, or other message. For example, the centralized database may monitor incoming transaction information to determine when a customer redeems an offer at a retailer.

In an example embodiment, an institution may receive data from the centralized database for analysis. Such analysis may include, for example, identification of customers for advertising. The institution may target a customer with existing media types, and further extend targeting outside customer base with lookalike modeling. Also, the institution may utilize the information to determine customer trends and tendencies. The institution may also utilize the information to categorize a user into one or more categories (e.g. heavy spender, new to credit, etc.).

In an example embodiment, a central party (which may be a financial institution) may develop a centralized database for storing information. Other financial institutions may send a customer list to the central party that would identify unique customers (and customer overlap) and assign a unique ID to teach customer. Once this information is established, financial institutions may regularly send customer and/or transaction information to the central party for collection and storage. The central party may then develop usage limitations for each other financial institution. Other financial institutions would request information regarding a specific customer from the central party, who would ensure that usage limitations are met, and then send the requesting institution the information requested. The receiving financial institution may receive this information and use it to deliver an offer to the customer, and then report the details of the offer back to the central party. The central party may then monitor the incoming data to determine if a transaction related to the offer has taken place.

The present disclosure is not to be limited in terms of the particular embodiments described in this application, which are intended as illustrations of various aspects. Many modifications and variations can be made without departing from its spirit and scope, as will be apparent. Functionally equivalent methods and apparatuses within the scope of the disclosure, in addition to those enumerated herein, will be apparent from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood, all language such as “up to,” “at least,” “greater than,” “less than,” and the like include the number recited and refer to ranges which can be subsequently broken down into subranges as discussed above. Finally, as will be understood, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent. The various aspects and embodiments disclosed herein are for purposes of illustration and are not intended to be limiting, with the true scope and spirit being indicated by the following claims.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system, comprising:
a communication module to facilitate communication with one or more institutions;
a centralized database that stores user information associated with a unique identifier;
one or more processors associated with the centralized database to receive transaction information and customer information from the one or more institutions and store said information in the centralized database; and
a request handler to receive requests for information one of the one or more institutions, determine whether the request complies with one or more usage limitations associated with the one of the one or more institutions, and provide the information to the one of the one or more institutions.

2. The system of claim 1, further comprising
one or more processors associated with the centralized database to monitor transaction information to determine whether provided information has been utilized by a user of the one of the one or more institutions.

3. The system of claim 1, wherein the one or more institutions are financial institutions.

4. The system of claim 3, wherein the transaction information comprises financial institution transaction data.

5. The system of claim 4, wherein the financial institution transaction data comprises purchase data.

6. The system of claim 1, wherein the one or more institutions are institutions that provide social media services.

7. The system of claim 6, wherein the transaction information comprises social media transaction data.

8. The system of claim 1, wherein the one or more usage limitations are based on the respective amount of information provided by each of the one or more institutions.

9. The system of claim 1, wherein the one or more usage limitations are proportional to the respective amount of information provided by each of the one or more institutions.

10. The system of claim 1, wherein the unique identifier identifies a user having accounts at more than one of the one or more institutions.

11. A method, comprising:
facilitating communication with one or more institutions via a network;
establishing a centralized database that stores user information associated with a unique identifier;
receiving transaction information and customer information at the centralized from the one or more institutions via the network;
storing said information in the centralized database;
receiving requests for information one of the one or more institutions via the network;
determining whether the request complies with one or more usage limitations associated with the one of the one or more institutions; and
providing the information to the one of the one or more institutions via the network.

12. The method of claim 11, further comprising
monitoring transaction information; and
determining whether provided information has been utilized by a user of the one of the one or more institutions.

13. The method of claim 11, wherein the one or more institutions are financial institutions.

14. The method of claim 13, wherein the transaction information comprises financial institution transaction data.

15. The method of claim 14, wherein the financial institution transaction data comprises purchase data.

16. The method of claim 11, wherein the one or more institutions are institutions that provide social media services.

17. The method of claim 16, wherein the transaction information comprises social media transaction data.

18. The method of claim 11, wherein the one or more usage limitations are based on the respective amount of information provided by each of the one or more institutions.

19. The method of claim 11, wherein the one or more usage limitations are proportional to the respective amount of information provided by each of the one or more institutions.

20. The method of claim 11, wherein the unique identifier identifies a user having accounts at more than one of the one or more institutions.
